(19) United States
(12) Patent Application Publication
(10) Pub. No.: US 2022/0167463 A1
(43) Pub. Date: May 26, 2022

(54) HEATER

(71) Applicant: NITTO DENKO CORPORATION, Ibaraki-shi, Osaka (JP)

(72) Inventors: Takeshi Tanaka, Osaka (JP); Yosuke Nakanishi, Osaka (JP); Toshihiro Tsurusawa, Osaka (JP); Kyotaro Yamada, Osaka (JP); Hironobu Machinaga, Osaka (JP); Naoko Kato, Osaka (JP)

(73) Assignee: NITTO DENKO CORPORATION, Ibaraki-shi, Osaka (JP)

(21) Appl. No.: 17/441,938

(22) PCT Filed: Mar. 11, 2020
(86) PCT No.: PCT/JP2020/010660

§ 371 Date: Sep. 22, 2021

(30) Foreign Application Priority Data
Mar. 29, 2019 (JP) 2019-067060

(51) Int. Cl. H05B 3/28

(52) U.S. Cl. CPC H05B 3/28

(57) ABSTRACT

A heater (1a) includes a substrate (10), a heating element (20) that is a transparent conductive film (20), an intermediate layer (30), and at least a pair of power supply electrodes (40). The intermediate layer (30) is disposed between the substrate (10) and the transparent conductive film (20), and has a first principal surface (31) positioned closer to the transparent conductive film (20) than the substrate (10). The pair of power supply electrodes (40) are in contact with the transparent conductive film (20). The intermediate layer (30) contains an organic polymer (32) forming a cured product and particles (34) of silica or a metal oxide dispersed in the cured product. The transparent conductive film (20) has a surface having an arithmetic average roughness Ra, specified in JIS B 0601:2013, of 7.0 nm or less.

### TECHNICAL FIELD

The present invention relates to a heater.

### BACKGROUND ART

Heaters including a transparent and conductive film have been conventionally known.

For example, Patent Literature 1 describes a heat-generating transparent body including a plastic substrate, a surface-cured film layer, a transparent conductive thin film layer, and a pair of metal electrodes. The surface-cured film layer is formed on at least one end surface of the plastic substrate. The transparent conductive thin film layer is formed on the surface-cured film layer, and is transparent to visible ray and electrically conductive. The pair of metal electrodes are provided facing a pair of peripheral end portions of the transparent conductive thin film layer. The surface-cured film layer is formed for example by curing a coating made of a polyfunctional acrylate, a coating made of a melamine compound, or an organosiloxane coating, or by plasma polymerization of a methoxysilane monomer.

Patent Literature 2 discloses a heat-generating resin substrate including a resin substrate, a transparent conductive film, a pair of electrodes, and a power source. The transparent conductive film is formed above a surface of the resin substrate, and generates heat upon receiving electric power supply. A buffer layer is provided between the resin substrate and the transparent conductive film to buffer the difference in thermal expansion and contraction therebetween. The buffer layer is formed of one or more compounds selected from the group consisting of titanium oxide, silicon oxide, niobium oxide, and silicon nitride. A coat layer may be formed on the surface of the resin substrate. A material of the coat layer can be a material obtained by adding inorganic oxide fine particles to a silicone resin containing an organopolysiloxane resin as a main component.

Patent Literature 3 describes a transparent planar heating element including a light-transmissive conductive film. The light-transmissive conductive film includes a light-transmissive support layer, a hard coat layer, a base layer, and a light-transmissive conductive layer. The hard coat layer is disposed on at least one of surfaces of the light-transmissive support layer, directly or via at least one other layer. The base layer is disposed adjacent to a surface of the hard coat layer that is opposite to the light-transmissive support layer. The light-transmissive conductive layer is disposed adjacent to the base layer. The base layer contains a simple substance of silicon. The hard coat layer preferably contains polyurethane, and may further contain fine inorganic particles such as silica fine particles for the purpose of refractive index adjustment or the like.

### CITATION LIST

### Patent Literatures

Patent Literature 1: JP S59-214183 A

Patent Literature 2: JP 2008-41343 A

Patent Literature 3: JP 2014-186985 A

### SUMMARY OF INVENTION

### Technical Problem

According to the technique described in Patent Literature 1, the surface-cured film layer contains no inorganic particle. Patent Literature 1 fails to describe an increase in adhesion of the transparent conductive thin film layer to the plastic substrate by containing inorganic particles in the surface-cured film layer. The coat layer of the heat-generating resin substrate described in Patent Literature 2 and the hard coat layer of the transparent planar heating element described in Patent Literature 3 may contain inorganic particles. However, Patent Literatures 2 and 3 fail to specifically study the surface state of the transparent conductive film. According to Patent Literatures 2 and 3, a further study needs to be conducted on the surface state of a transparent conductive film that is advantageous in the case where the adhesion of a transparent conductive film to a substrate is increased by containing inorganic fine particles in an intermediate layer disposed between the substrate and the transparent conductive film.

In view of such circumstances, the present invention provides a heater that is advantageous from the viewpoint of increasing adhesion of a transparent conductive film to a substrate to provide the transparent conductive film with desired properties, in the case where an intermediate layer containing inorganic particles is disposed between the substrate and the transparent conductive film.

### Solution to Problem

The present invention provides a heater including:

a substrate;

a transparent conductive film being a heating element;

an intermediate layer disposed between the substrate and the transparent conductive film, the intermediate layer having a first principal surface positioned closer to the transparent conductive film than the substrate; and

at least a pair of power supply electrodes electrically connected to the transparent conductive film, wherein

the intermediate layer contains an organic polymer forming a cured product and inorganic particles dispersed in the cured product, and

the transparent conductive film has a surface having an arithmetic average roughness Ha, specified in Japanese Industrial Standards (JIS) B 0601:2013, of 7.0 nm or less.

### Advantageous Effects of Invention

The intermediate layer of the above heater is advantageous from the viewpoint of increasing the adhesion of the transparent conductive film to the substrate to provide the transparent conductive film with the desired properties.

### BRIEF DESCRIPTION OF DRAWINGS

FIG. 1 is a cross-sectional view showing an example of a heater according to the present invention.

FIG. 2 is a cross-sectional view showing another example of the heater according to the present invention.

FIG. 3 is a cross-sectional view showing an example of a heater-equipped article.

### DESCRIPTION OF EMBODIMENTS

As a result of repeated studies on a heater including a transparent conductive film that is a heating element, the present inventors invented the heater according to the present invention based on the following new findings.

In producing a heater by forming a transparent conductive film that is a heating element on a substrate, it is conceivable to dispose an intermediate layer containing an organic polymer forming a cured product between the substrate and the transparent conductive film to increase mechanical strength of the heater. In this case, it is conceivable that inorganic particles are contained in the intermediate layer, from the viewpoint of improving the adhesion of the transparent conductive film. It is considered that the adhesion of the transparent conductive film improves owing to a chemical interaction between the inorganic particles and the transparent conductive film or a chemical interaction between the inorganic particles and a substance that is present disposed between the inorganic particles and the transparent conductive film. In addition, when the transparent conductive film having a surface having a predetermined surface roughness is formed owing to an action of the inorganic particles, a contact area is large between the transparent conductive film and a layer in contact with the transparent conductive film. This is considered to allow the transparent conductive film to easily have a further improved adhesion. Meanwhile, the studies by the present inventors proved that the arithmetic average roughness Ra of the surface of the transparent conductive film influences properties of the transparent conductive film. In view of this, the present inventors repeated much trial and error and thus invented a heater advantageous for providing a transparent conductive film with desired properties.

Hereinafter, embodiments of the present invention will be described with reference to the drawings. The following embodiments describe merely illustrative implementation of the present invention, and the present invention is not limited to the following embodiments. Note that the phrase “have a transparency to light having a predetermined wavelength λₑ” as used herein typically refers to have a transmissivity of 60% or more for light having the wavelength λₚ.

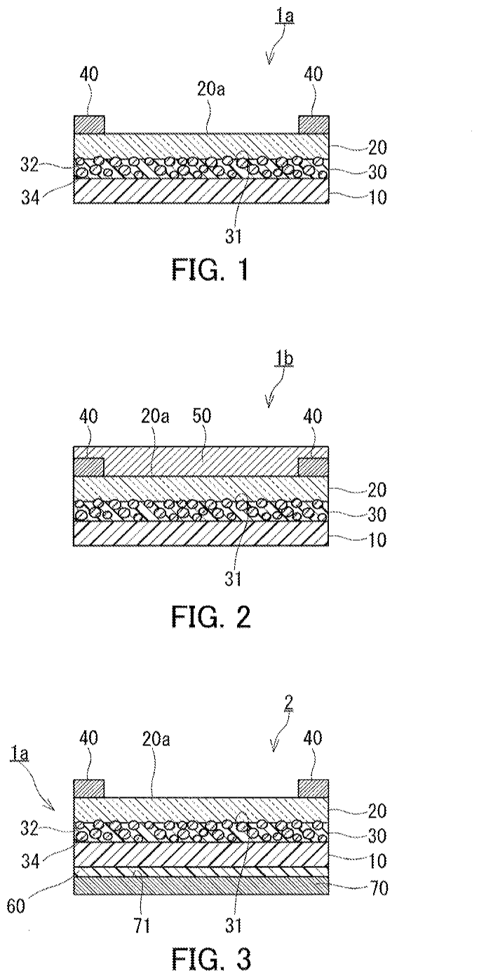

As shown in FIG. 1, a heater 1a includes a substrate 10, a transparent conductive film 20 that is a heating element, an intermediate layer 30, and at least a pair of power supply electrodes 40. The intermediate layer 30 is disposed between the substrate 10 and the transparent conductive film 20. The intermediate layer 30 has a first principal surface 31. The first principal surface 31 is positioned closer to the transparent conductive film 20 than the substrate 10. At least one pair of power supply electrodes 40 are electrically connected to the transparent conductive film 20. The pair of power supply electrodes 40 can be connected to a power source (not shown). The pair of power supply electrodes 40 as used herein refer to a pair made up of an anode and a cathode. In the case where one of the pair of power supply electrodes 40 functions as an anode, the other power supply electrode 40 functions as a cathode. An electric power from the power source is supplied to the transparent conductive film 20, which is a heating element, by the pair of power supply electrodes 40, and thus the transparent conductive film 20 generates heat. The transparent conductive film 20 has a surface 20a having an arithmetic average roughness Ha, specified in JIS B 0601:2013, of 7.0 nm or less. The intermediate layer 30 contains an organic polymer 32 and inorganic particles 34. The organic polymer 32 forms a cured product. In the cured product, the organic polymer 32 may be cross-linked or not. The cured product can also be formed by aggregation of the organic polymer 32 without cross-linking. The inorganic particles 34 are dispersed in the cured product. The term “average particle diameter” as used herein refers to a median diameter (D50). The median diameter indicates a particle diameter that is determined to have a value such that the number of particles having a particle diameter larger than the value is equal to the number of particles having a particle diameter smaller than the value.

Since the intermediate layer 30 contains the inorganic particles 34, adhesion of the transparent conductive film 20 is increased. In addition, since the surface 20a of the transparent conductive film 20 has an arithmetic average roughness Ra of 7.0 nm or less, the material forming the transparent conductive film 20 is in an appropriate state, and thus the transparent conductive film 20 has desired properties. For example, a low specific resistance of the transparent conductive film 20 can be achieved easily. A low specific resistance of the transparent conductive film 20 is advantageous from the viewpoint of keeping an amount of heat generation in the heater 1a high even with a small thickness of the transparent conductive film 20. The transparent conductive film 20 having a small thickness is less likely to crack.

The lower limit for the arithmetic average roughness Ra of the surface 20a of the transparent conductive film 20 is not particularly limited, and may be for example 0.05 nm or more. The arithmetic average roughness Ra of the transparent conductive film 20 is desirably 0.1 to 5.5 nm, and more desirably 0.2 to 4.5 nm.

The substrate 10 for example has a transparency to light having a predetermined wavelength such as visible light or near-infrared light. The substrate 10 is for example made of an organic polymer. The substrate 10 is for example made of at least one selected from the group consisting of polyethylene terephthalates, polyethylene naphthalates, polyimides, polycarbonates, polyether ether ketones, and aromatic polyamides.

The thickness of the substrate 10 is not limited to a particular thickness, but is for example 10 μm to 200 μm from the viewpoint of favorable transparency, favorable strength, and ease of handling. The thickness of the substrate 10 may be 20 to 180 μm, or may be 30 to 160 μm.

The organic polymer 32, which forms the cured product, in the intermediate layer 30 is not particularly limited. In the intermediate layer 30, the organic polymer 32 plays a role as a binder binding the inorganic particles 34. The organic polymer 32 for example has a transparency to light having a predetermined wavelength such as visible light or near-infrared light. The organic polymer may be an active energy ray-curable resin, or may be other resin. The active energy ray-curable resin is for example a (meth)acrylic ultraviolet-curable resin such as a urethane acrylate resin or an epoxy acrylate resin. Also, the resin other than the active energy ray-curable resin is for example a urethane resin, a melamine resin, an alkyd resin, or a siloxane polymer resin.

An inorganic substance included in the inorganic particles 34 is not particularly limited. The inorganic substance can be metal, a metal oxide, or silica. The inorganic particles 34 desirably contain at least one of silica and a metal oxide. This case can achieve an increase in adhesion of the transparent conductive film 20 and easily achieve a transparency of the intermediate layer 30 to light having a predetermined wavelength such as a visible light or a near-infrared light.

The thickness of the intermediate layer 30 is for example 0.5 to 8 μm. Thus, the mechanical strength of the heater 1a can be increased and the thickness of the heater 1a can be reduced.

The average particle diameter of the inorganic particles 34 is not particularly limited as long as the surface 20a of the transparent conductive film 20 has an arithmetic average roughness Ha within the above range. For example, the average particle diameter of the inorganic particles 34 is 4 to 5000 nm. The average particle diameter of the inorganic particles 34 is desirably 6 to 3000 nm, and more desirably 8 to 2000 nm.

In the case where the inorganic particles 34 are particles of a metal oxide, the metal oxide can be for example zirconia, titania, or alumina.

The content of the inorganic particles 34 in the intermediate layer 30 is for example 2.0 to 90% on a weight basis. This is advantageous from the viewpoint of adjusting the arithmetic average roughness Ha of the surface 20a of the transparent conductive film 20 to fall within the above range. The content of the inorganic particles 34 in the intermediate layer 30 is desirably 3.0 to 85% on the weight basis, and more desirably 5.0 to 80% on the weight basis. The content of the inorganic particles 34 in the intermediate layer 30 may be 10% or more, desirably 15% or more, and more desirably 20% or more.

For example, a distance between the first principal surface 31 and the transparent conductive film 20 in a thickness direction of the intermediate layer 30 is 500 nm or less. In this case, the inorganic particles 34 are present near the transparent conductive film 20, and thus the adhesion of the transparent conductive film 20 is further reliably increased owing to a chemical action of the inorganic particles 34. A layer formed of an inorganic substance such as a metal oxide may be present between the transparent conductive film 20 and the intermediate layer 30. Such a layer can for example serve as a base for forming the transparent conductive film 20. This case allows the transparent conductive film 20 to easily have a further increased adhesion. The distance between the first principal surface 31 and the transparent conductive film 20 in the thickness direction of the intermediate layer 30 is for example 400 nm or less, or 300 nm or less, and can be 200 nm or less.

As shown in FIG. 1, the transparent conductive film 20 may be in contact with the first principal surface 31. Even in this case, since the arithmetic average roughness Ha of the surface 20a of the transparent conductive film 20 is adjusted to fall within the above range, the desired properties of the transparent conductive film 20 can be obtained easily. In this case, for example, at least portion of the inorganic particles 34 is partially exposed on the first principal surface 31. Accordingly, at least portion of the inorganic particles 34 is in contact with the transparent conductive film 20. This increases a chemical interaction between the inorganic particles 34 and the transparent conductive film 20, thereby further easily increasing the adhesion of the transparent conductive film 20.

The transparent conductive film 20 has a specific resistance of for example 3.5×10⁻⁴ Ω·cm or less. Thus, the amount of heat generation in the heater 1a can be kept high even with the transparent conductive film 20 having a small thickness. The transparent conductive film 20 has a specific resistance of desirably 3.0×10⁻⁴ Ω·cm or less, and more desirably 2.5×10⁻⁴ Ω·cm or less. The transparent conductive film 20 has a specific resistance of for example 1.4×10⁻⁴ Ω·cm or more.

The transparent conductive film 20 is for example a polycrystal. This is advantageous to provide the transparent conductive film 20 with the desired properties. For example, in the case where the transparent conductive film 20 is a polycrystal, a low specific resistance of the transparent conductive film 20 can be achieved easily.

For example, the transparent conductive film 20 has a carrier density of 8.0×10²⁰ cm⁻³ or more as determined by Hall effect measurement. This is advantageous from the viewpoint of lowering the specific resistance of the transparent conductive film 20. The carrier density of the transparent conductive film 20 is desirably 9.0×10²⁰ cm⁻³ or more, and more desirably 1.0×10²¹ cm⁻³ or more. The carrier density of the transparent conductive film 20 is for example 2.0×10²¹ cm⁻³ or less, may be 1.8×10²¹ cm⁻³ or less, or may be 1.5×10²¹ cm⁻³ or less. The Hall effect measurement is performed according to the van der Pauw method, for example.

For example, the transparent conductive film 20 has a Hall mobility of 14 cm²/(V·s) or more as determined by the Hall effect measurement. This is advantageous from the viewpoint of lowering the specific resistance of the transparent conductive film 20. The Hall mobility of the transparent conductive film 20 is desirably 16 cm²/(V·s) or more, and more desirably 18 cm²/(V·s) or more.

The Hall mobility of the transparent conductive film 20 is for example 30 cm²/(V·s) or less, desirably 27 cm²/(V·s) or less, and more desirably 25 cm²/(V·s) or less.

The transparent conductive film 20 contains for example an indium oxide as a main component. This is advantageous from the viewpoint of providing the transparent conductive film 20 with the desired properties. For example, in the case where the transparent conductive film 20 containing an indium oxide as a main component, a low specific resistance of the transparent conductive film 20 can be achieved easily. The term “main component” as used herein refers to a component whose content on the weight basis is the highest.

The material forming the transparent conductive film 20 is desirably an indium tin oxide (ITO). In this case, the content of tin oxide in ITO is for example 4 to 14 wt %, and desirably 5 to 13 wt %. The ITO forming the transparent conductive film 20 desirably has a polycrystalline structure. This is advantageous from the viewpoint of lowering the specific resistance of the transparent conductive film 20.

The thickness of the transparent conductive film 20 is for example 20 to 200 nm. Thus, the heater 1a can exhibit favorable temperature rise performance and cracking is less likely to occur in the transparent conductive film 20. The thickness of the transparent conductive film 20 is desirably 25 to 180 nm, and more desirably 27 to 170 nm.

For example, the pair of power supply electrodes 40 have a thickness of 1 μm or more. Thus, the pair of power supply electrodes 40 are less likely to be damaged when the heater 1a is operated at a high temperature rise rate. Note that the pair of power supply electrodes 40 are much thicker than electrodes formed on a transparent conductive film used in display devices such as a touch panel. The thickness of the power supply electrodes 40 may be 2 μm or more, 3 μm or more, or 5 μm or more. The thickness of the first power supply electrodes 40 is for example 5 mm or less, may be 1 mm or less, or may be 700 μm or less.

The intermediate layer 30 can be formed by for example applying a coating film containing the organic polymer 32 or a precursor of the organic polymer 32 and the inorganic particles 34 to a principal surface of the substrate 10 to form a coating film, and curing the coating film. The coating liquid can be adjusted by for example adding the organic polymer 32 or the precursor of the organic polymer 32 to a dispersion of the inorganic particles 34 and stirring a resultant mixture. The coating liquid contains an additive such as a crosslinking agent, a polymerization initiator, or a surfactant, as necessary. In curing the coating film, the coating film is for example heated under a predetermined condition. In curing the coating film, the coating film may be irradiated with active energy ray such as ultraviolet ray under a predetermined condition. As necessary, a layer serving as a base for forming the transparent conductive film 20 may be formed on a surface of the intermediate layer 30. This base can be for example a layer of an inorganic substance such as a metal oxide.

The transparent conductive film 20 is formed by for example sputtering. The transparent conductive film 20 is obtained desirably by performing sputtering using a target material to form a thin film derived from the target material on the first principal surface 31 of the intermediate layer 30. The thin film derived from the target material is formed on the first principal surface 31 more desirably by high magnetic field DC magnetron sputtering. In this case, the transparent conductive film 20 can be formed at low temperatures. Accordingly, for example, even when the heat resistant temperature of the substrate 10 is not high, the transparent conductive film 20 can be formed on the first principal surface 31. In addition, defects are less likely to occur in the transparent conductive film 20, and thus a low internal stress of the transparent conductive film 20 can be achieved easily. Also, by adjusting the conditions for sputtering, a thin film that is desirable as the transparent conductive film 20 can be formed easily. For example, by adjusting the horizontal magnetic field on a surface of a target material to a predetermined value in high magnetic field DC magnetron sputtering, the Hall mobility of the transparent conductive film 20 is increased, thereby easily obtaining the transparent conductive film 20 desirable in terms of specific resistance.

The thin film formed on the first principal surface 31 of the intermediate layer 30 is subjected to annealing, as necessary. For example, the thin film is annealed by being placed in the air at 120° C. to 150° C. for 1 to 3 hours. This facilitates crystallization of the thin film, and thus the transparent conductive film 20, which is a polycrystal, is formed advantageously. When the temperature of the environment in which the annealing treatment of the thin film is performed and the time period for performing the annealing treatment are within the above-described ranges, the heat resistant temperature of the substrate 10 need not necessarily be high, and an organic polymer can be used as the material of the substrate 10. In addition, defects are less likely to occur in the transparent conductive film 20, and thus a low internal stress of the transparent conductive film 20 can be achieved more easily. By adjusting the conditions for the annealing treatment, the transparent conductive film 20 desirable in terms of specific resistance can be obtained easily. For example, by limiting the amount of oxygen supplied during the annealing treatment within a predetermined range, a polycrystalline transparent conductive film having a high carrier density can be obtained easily. Accordingly, the specific resistance of the transparent conductive film 20 can be easily adjusted to fall within a desired range.

The transparent conductive film 20 may be formed not by sputtering but by a method such as vacuum deposition or ion plating.

The pair of power supply electrodes 40 are formed in the following manner, for example. A seed layer is formed on a principal surface of the transparent conductive film 20 by a dry process such as chemical vapor deposition (CVD) or physical vapor deposition (PVD) or by plating. Next, a masking film is placed on portions of the seed layer where the power supply electrodes 40 are not to be formed. The masking film can be produced by layering a resist on the seed layer and then performing exposure and development processes. Subsequently, a metal film having a thickness of 1 μm or more is formed on portions of the seed layer where the masking film is not placed, by a wet process such as plating. Next, the masking film placed on the seed layer is removed, and the metal film for forming the power supply electrodes 40 becomes covered with a masking film formed using a resist. Next, exposed portions of the seed layer are removed by etching. Subsequently, the masking film is removed, and the pair of power supply electrodes 40 thus can be formed. The pair of power supply electrodes 40 may be formed in the following manner. First, a seed layer is formed on the principal surface of the transparent conductive film 20, as described above. Subsequently, a metal film having a thickness of 1 μm or more is formed on the principal surface of the transparent conductive film 20 by a dry process such as CVD or PVD or by a wet process such as plating. Next, portions of a metal film for forming the power supply electrodes 40 become covered with a masking film formed using a resist. Subsequently, unnecessary portions of the metal film are removed by etching, and the masking film is removed. The pair of power supply electrodes 40 are thus formed. Alternatively, the power supply electrodes 40 may be formed by applying an electrically conductive ink onto the principal surface of the transparent conductive film 20 in a predetermined pattern and curing the applied electrically conductive ink. The power supply electrodes 40 may be formed by applying an electrically conductive paste onto the principal surface of the transparent conductive film 20 in a predetermined pattern with an application method such as application using a dispenser or screen printing, and curing the applied electrically conductive paste. The electrically conductive paste typically contains a filler of an electrically conductive material such as silver. The power supply electrodes 40 may be formed using solder paste.

The heater 1a can be modified in various respects. For example, the heater 1a may be modified so as to have the configuration of a heater 1b shown in FIG. 2. Unless otherwise stated, the configuration of the heater 1b is the same as the configuration of the heater 1a. Components of the heater 1b that are the same as or correspond to those of the heater 1a are given the same reference numerals, and detailed descriptions thereof are omitted. The descriptions regarding the heater 1a also apply to the heater 1b, unless technically incompatible.

As shown in FIG. 2, the heater 1b further includes a protective layer 50. The protective layer 50 is disposed such that the transparent conductive film 20 is positioned between the protective layer 50 and the intermediate layer 30. The protective layer 50 includes, for example, a predetermined protective film and a pressure-sensitive adhesive layer for attaching the protective film to the transparent conductive film 20. The material forming the transparent conductive film 20 typically has low toughness. On this account, the transparent conductive film 20 is protected by the protective layer 50, and this allows the heater 1b to have high impact resistance. The material of the protective film included in the protective layer 50 is not particularly limited, and may be, for example, a synthetic resin such as a fluororesin, silicone, an acrylic resin, or polyester. The thickness of the protective film is not particularly limited, and is for example 20 to 200 μm. This can prevent the heater 1b from having an excessively large thickness, while the heater 1b has favorable impact resistance. The pressure-sensitive adhesive layer is formed of a known pressure-sensitive adhesive such as an acrylic pressure-sensitive adhesive, for example. In the case where the protective film itself has pressure-sensitive adhesion, the protective layer 50 may be formed only of the protective film, for example.

A heater-equipped article can be produced using the heater 1a. For example, as shown in FIG. 3, a heater-equipped article 2 includes a molded body 70, a pressure-sensitive adhesive layer 60, and the heater 1a. The molded body 70 has an adherend surface (surface to be subjected to adhesion) 71. The molded body 70 is formed of a metal material, a glass, or a synthetic resin. The pressure-sensitive adhesive layer 60 is in contact with the adherend surface 71. The pressure-sensitive adhesive layer 60 is formed of a known pressure-sensitive adhesive such as an acrylic pressure-sensitive adhesive, for example. The heater 1a is in contact with the pressure-sensitive adhesive layer 60 and is attached to the molded body 70 with the pressure-sensitive adhesive layer 60.

The adhesive layer 60 may be formed beforehand on, for example, one of a principal surfaces of the substrate 10 that is more distant from the intermediate layer 30 than the other principal surface is. In this case, the heater 1a can be attached to the molded body 70 by pressing the heater 1a against the molded body 70 in the state where the pressure-sensitive adhesive layer 60 and the adherend surface 71 face each other. The pressure-sensitive adhesive layer 60 may be covered with a separator (not shown). In this case, the separator is peeled off at the time of attaching the heater 1a to the molded body 70 to expose the pressure-sensitive adhesive layer 60. The separator 60 is, for example, a film made of a polyester resin such as polyethylene terephthalate (PET).

For example, in an apparatus configured to execute processing using near-infrared light, the heater 1a is disposed on the optical path of this near-infrared light. This apparatus executes predetermined processing such as sensing or communication using near-infrared light, for example. The molded body 70 constitutes, for example, a housing of such an apparatus.

### EXAMPLES

Hereinafter, the present invention will be described in more detail with reference to examples. The present invention is not limited to the following examples. First, evaluation methods and measurement methods used in the examples and comparative examples will be described.

[Arithmetic Average Roughness Ra of Surface of Transparent Conductive Film]

Shape measurement was performed on surfaces of transparent conductive films (heating elements) of a heater according to each of the examples and the comparative examples in accordance with JIS R 1683:2014, using an atomic force microscope (AFM) (manufactured by Bruker Japan K.K., product name: MultiMode 8). Based on results of the measurement, an arithmetic average roughness Ra specified in JIS B 0601:2013 was determined with respect to the surface of the transparent conductive film (heating element) of the heater according to each of the examples and the comparative examples. The results are shown in Table 1. Ideally, it is direct to measure an arithmetic average roughness Ra of a surface of the intermediate layer. However, owing to the arithmetic average roughness Ra of the surface of the transparent conductive film being approximate to the arithmetic average roughness Ra of the surface of the intermediate layer, the arithmetic average roughness Ra of the transparent conductive film can be used instead to evaluate the shape of the surface of the intermediate layer.

[Thickness Measurement of Intermediate Layer]

A laminate including the intermediate layer was cut along its cross section using a microtome (manufactured by Hitachi High-Tech Fielding Corporation, product name: UC7). Observation was performed on at least three parts randomly selected on the cross-section of the laminate to measure the thickness of the intermediate layer, using a scanning electron microscope (manufactured by Hitachi High-Technologies Corporation, product name: S-4800). An arithmetic mean of the measured values was determined as the thickness of the intermediate layer. The results are shown in Table 1.

[Thickness Measurement of Transparent Conductive Film and Power Supply Electrodes]

The thickness of the transparent conductive film (heating element) of the heater according to each of the examples and the comparative examples was measured by X-ray reflectometry using an X-ray diffractometer (manufactured by Rigaku Corporation, product name: RINT 2200). The results are shown in Table 1. Also, the X-ray diffraction pattern of the transparent conductive film was obtained using the X-ray diffractometer. The X-rays used in the measurement were Cu-Kα X-rays. From the X-ray diffraction patterns obtained, it was confirmed that the respective transparent conductive films according to the examples and the comparative examples had a polycrystalline structure. Also, the thickness of each power supply electrode of the heater according to each of the examples and the comparative examples was measured by measuring the height of an end portion of the power supply electrode of the heater according to each of the examples and the comparative examples, using a scanning electron microscope (manufactured by Hitachi High-Technologies Corporation, product name: S-4800). The results are shown in Table 1.

[Sheet Resistance and Specific Resistance]

The sheet resistance of the transparent conductive film (heating element) of the heater according to each of the examples and the comparative examples was measured in accordance with JIS Z 2316-1: 2014 by an eddy current method, using a non-contact type resistance measurement instrument (manufactured by Napson Corporation, product name: NC-80MAP). In addition, a product of the thickness of the transparent conductive film (heating element) obtained in the thickness measurement and the sheet resistance of the transparent conductive film (heating element) was calculated thus to determine the specific resistance of the transparent conductive film (heating element) of the heater according to each of the examples and the comparative examples. The results are shown in Table 1.

[Hall Effect Measurement]

The transparent conductive film (heating element) of the heater according to each of the examples and the comparative examples was subjected to Hall effect measurement according to the van der Pauw method, using a Hall effect measurement system (manufactured by TOYO Corporation, product name: ResiTest 8400). From the results of the Hall effect measurement, the Hall mobility and the carrier density of the transparent conductive film (heating element) of the heater according to each of the examples and the comparative examples was determined.

The results are shown in Table 1.

[Energization Test]

Using a constant voltage DC power supply manufactured by Kikusui Electronics Corp., an energization test was performed by applying a voltage of 12 V to the pair of power supply electrodes of the heater according to each of the examples and the comparative examples to cause a current to flow through the transparent conductive film (heating element) of the heater. Wiring for connecting the heater to the power source is attached to end portions of the respective power supply electrodes on the same side in the longitudinal direction. During the energization test, the surface temperature of the transparent conductive film (heating element) was measured using a thermograph manufactured by FLIR Systems, Inc., and the temperature rise rate was calculated. The temperature rise performance of the heater was evaluated in accordance with the following criteria.

A: Temperature rise rate of 80° C./min or more

X: Temperature rise rate of less than 80° C./min

[Adhesion Evaluation]

The adhesion was evaluated on the surface of the heater according to each of the examples and the comparative examples by the following method. On the surface of the transparent conductive film of a sample cut from the heater according to each of the examples and the comparative examples, a lattice-shaped cut was formed by forming six slits extending linearly in the same direction and forming six slits extending linearly in a direction perpendicular to the six slits. The interval between the slits is 1 mm, and the slits each extend through the surface of the substrate. An adhesive tape was attached so as to cover the lattice-shaped cut and along a direction parallel to the six slits extending linearly in the same direction, and then the adhesive tape was peeled off. The lattice-shaped cut after peel-off of the adhesive tape was observed, and the adhesion of the transparent conductive film was evaluated in accordance with the following criteria. Note that conditions for lattice-shaped cut formation, adhesive tape attachment, and adhesive tape peel-off were specified in accordance with JIS K 5600-5-6:1999.

A: No square in the lattice-shaped cut was peeled off.

X: At least one of squares in the lattice-shaped cut was peeled off.

### Example 1

A coating liquid according to Example 1 was prepared that contains an ultraviolet-curable acrylic resin (manufactured by Arakawa Chemical Industries, Ltd., product name: OPSTAR Z7540) and silica particles (average particle diameter: 10 nm). The content of silica particles in solids of the coating liquid according to Example 1 was 60% on the weight basis.

The coating liquid according to Example 1 was applied onto one of principal surfaces of a polyethylene naphthalate (PEN) film (manufactured by Teijin Film Solutions Limited, product name: TEONEX) having a thickness of 125 μm that is a substrate. A coating film was thus formed. This coating film was irradiated with ultraviolet ray to cure the coating film thus to form an intermediate layer.

An ITO film was formed on the intermediate layer by DC magnetron sputtering using indium tin oxide (ITO) (tin oxide content: 10 wt %) as a target material in a high magnetic field with the magnetic flux density of the horizontal magnetic field on the surface of the target material being 80 to 150 mT (millitesla) and in the presence of an inert gas. The PEN film with the ITO film formed thereon was annealed by being placed in the air at 150° C. for 3 hours. As a result, ITO was crystallized, whereby a transparent conductive film was formed.

Next, a strip-shape section was cut out from the PEN film with the transparent conductive film formed thereon, and a Cu thin film (seed layer) having a thickness of 100 nm was formed by DC magnetron sputtering. Next, the Cu thin film was subjected to wet plating to form a Cu thin film having a thickness of 20 μm. Next, a pair of end portions of the Cu film became covered with a masking film formed using a resist. Exposed portions of the Cu film were removed by etching. Subsequently, the masking film was removed, and thus a pair of power supply electrodes were formed in portions corresponding to a pair of end portions of the transparent conductive film. The heater according to Example 1 was thus produced.

### Example 2

A coating liquid according to Example 2 was prepared that contains an ultraviolet-curable acrylic resin (manufactured by DIC Corporation, product name: V6850) and silica particles (average particle diameter: 10 nm). The content of silica particles in solids of the coating liquid according to Example 2 was 50% on the weight basis. The heater according to Example 2 was produced in the same manner as in Example 1, except that the coating liquid according to Example 2 was used instead of the coating liquid according to Example 1.

### Example 3

A coating liquid according to Example 3 was prepared in the same manner as in Example 2, except that the content of silica particles in solids of the coating liquid was adjusted to 53% on the weight basis. The heater according to Example 3 was produced in the same manner as in Example 1, except that the coating liquid according to Example 3 was used instead of the coating liquid according to Example 1.

### Example 4

A coating liquid according to Example 4 was prepared in the same manner as in Example 2, except that the content of silica particles in solids of the coating liquid was adjusted to 54% on the weight basis. The heater according to Example 4 was produced in the same manner as in Example 1, except that the coating liquid according to Example 4 was used instead of the coating liquid according to Example 1.

### Example 5

A coating liquid according to Example 5 was prepared in the same manner as in Example 2, except that the content of silica particles in solids of the coating liquid was adjusted to 8% on the weight basis. The content of silica particles in solids of the coating liquid according to Example 1 was 8% on the weight basis. The heater according to Example 5 was produced in the same manner as in Example 1, except that the coating liquid according to Example 5 was used instead of the coating liquid according to Example 1.

### Example 6

The heater according to Example 6 was produced in the same manner as in Example 1, except that the coating liquid according to Example 5 was used instead of the coating liquid according to Example 1 and that a condition of coating liquid application was adjusted such that the intermediate layer has a thickness of 0.7 μm.

### Example 7

A coating liquid according to Example 7 was prepared that contains an ultraviolet-curable acrylic resin (manufactured by Arakawa Chemical Industries, Ltd., product name: OPSTAR Z7540) and silica particles (average particle diameter: 50 nm). The content of silica particles in solids of the coating liquid according to Example 7 was 60% on the weight basis. The heater according to Example 7 was produced in the same manner as in Example 1, except that the coating liquid according to Example 7 was used instead of the coating liquid according to Example 1.

### Example 8

A coating liquid according to Example 8 was prepared that contains an ultraviolet-curable acrylic resin (manufactured by Arakawa Chemical Industries, Ltd., product name: OPSTAR Z7540) and silica particles (average particle diameter: 1800 nm). The content of silica particles in solids of the coating liquid according to Example 8 was 30% on the weight basis. The heater according to Example 8 was produced in the same manner as in Example 1, except that the coating liquid according to Example 8 was used instead of the coating liquid according to Example 1.

### Example 9

A coating liquid according to Example 9 was prepared that contains an ultraviolet-curable acrylic resin (manufactured by Arakawa Chemical Industries, Ltd., product name: OPSTAR Z7540) and zirconia particles (average particle diameter: 10 nm). The content of silica particles in solids of the coating liquid according to Example 9 was 60% on the weight basis. The heater according to Example 9 was produced in the same manner as in Example 1, except that the coating liquid according to Example 9 was used instead of the coating liquid according to Example 1.

### Example 10

The heater according to Example 10 was produced in the same manner as in Example 2, except that a polyethylene terephthalate (PET) film (manufactured by Mitsubishi Chemical Corporation, product name: DIAFOIL) having a thickness of 125 μm was used instead of a PEN film (manufactured by Teijin Film Solutions Limited, product name: TEONEX) having a thickness of 125 μm.

### Example 11

A strip-shaped section was cut out from the PEN film produced in Example 1 with the transparent conductive film formed thereon. The transparent conductive oxide layer became partially covered with a masking film in such a manner that a pair of end portions of the transparent conductive film facing each other were exposed. In this state, a silver paste (manufactured by TOYOBO CO., LTD., product name: DW-114L-1, specific resistance: 35 μΩ·cm) was applied onto the exposed portions of the transparent conductive film using a dispenser so as to have a width of 1 mm and a thickness of 60 μm. The silver paste was dried in an environment of 150° C. for 30 minutes so as to be cured. Subsequently, the masking film was removed, and thus a pair of power supply electrodes were formed in portions corresponding to a pair of end portions of the transparent conductive film. The heater according to Example 11 was thus produced.

### Comparative Example 1

A coating liquid according to Comparative Example 1 was prepared in the same manner as in Example 2, except that the content of silica particles in solids of the coating liquid was adjusted to 55% on the weight basis. The heater according to Comparative Example 1 was produced in the same manner as in Example 1, except that the coating liquid according to Comparative Example 1 was used instead of the coating liquid according to Example 1.

### Comparative Example 2

A coating liquid according to Comparative Example 2 was prepared that contains an ultraviolet-curable acrylic resin (manufactured by DIC Corporation, product name: V6850) and no inorganic particle. The heater according to Comparative Example 2 was produced in the same manner as in Example 1, except that the coating liquid according to Comparative Example 2 was used instead of the coating liquid according to Example 1.

As shown in Table 1, the heaters according to Examples 1 to 11 exhibited favorable temperature rise performance. In contrast, the heater according to Comparative Example 1 exhibited low temperature rise performance compared to the heaters according to Examples 1 to 11. In comparison between each of Examples 1 to 11 and Comparative Example 1, the specific resistances of the transparent conductive films of the heaters according to Examples 1 to 11 were lower than the specific resistance of the transparent conductive film of the heater according to Comparative Example 1. Accordingly, it is considered that the temperature rise performance of the heaters according to Examples 1 to 11 were favorable compared to the temperature rise performance of the heater according to Comparative Example 1. Also, while the heaters according to Examples 1 to 11 exhibited the arithmetic average roughness Ra of 7.0 nm or less of the surface of the transparent conductive film, the heater according to Comparative Example 1 exhibited the arithmetic average roughness Ra of more than 7.0 nm of the surface of the transparent conductive film. This is considered to have cause a difference in specific resistance of the transparent conductive film between the heater according to each of Examples 1 to 11 and the heater according to Comparative Example 1. Accordingly, it is suggested that the arithmetic average roughness Ra of the surface of the transparent conductive film should be adjusted to 7.0 nm or less to achieve favorable properties of the transparent conductive film. Furthermore, the comparison between the heater according to each of Examples 1 to 11 and the heater according to Comparative Example 2 suggests an increase in adhesion of the transparent conductive thin film layer owing to inorganic particles contained in the intermediate layer.

TABLE 1

| | | | Intermediate layer | | | | | | |
|---|---|---|---|---|---|---|---|---|---|
| | | | | Inorganic | | | | | |
| | | | | particle | Inorganic | | Transparent | | |
| | Substrate | | | average | particle | | conductive film (heating element) | | |
| | | THKNS | Inorganic | diameter | content | THKNS | | Crystal | Ra |
| | Material | [μm] | particles | [nm] | [wt %] | [μm] | Material | structure | [nm] |
| Ex. 1 | PEN | 125 | SiO₂ | 10 | 60 | 1.7 | ITO | Polycrystal | 0.3 |
| Ex. 2 | PEN | 125 | SiO₂ | 10 | 50 | 1.7 | ITO | Polycrystal | 1.5 |
| Ex. 3 | PEN | 125 | SiO₂ | 10 | 53 | 1.8 | ITO | Polycrystal | 5.0 |
| Ex. 4 | PEN | 125 | SiO₂ | 10 | 54 | 1.8 | ITO | Polycrystal | 6.1 |
| Ex. 5 | PEN | 125 | SiO₂ | 10 | 8 | 1.8 | ITO | Polycrystal | 1.1 |
| Ex. 6 | PEN | 125 | SiO₂ | 10 | 8 | 0.7 | ITO | Polycrystal | 1.7 |
| Ex. 7 | PEN | 125 | SiO₂ | 50 | 60 | 2.0 | ITO | Polycrystal | 0.9 |
| Ex. 8 | PEN | 125 | SiO₂ | 1800 | 30 | 2.0 | ITO | Polycrystal | 1.2 |
| Ex. 9 | PEN | 125 | ZrO₂ | 10 | 60 | 2.1 | ITO | Polycrystal | 2.1 |
| Ex. 10 | PET | 125 | SiO₂ | 10 | 50 | 1.8 | ITO | Polycrystal | 2.0 |
| Ex. 11 | PEN | 125 | SiO₂ | 10 | 60 | 1.7 | ITO | Polycrystal | 0.3 |
| Comparative | PEN | 125 | SiO₂ | 10 | 55 | 1.8 | ITO | Polycrystal | 9.2 |
| Ex. 1 | | | | | | | | | |
| Comparative | PEN | 125 | — | — | — | 1.7 | ITO | Polycrystal | 1.0 |
| Ex. 2 | | | | | | | | | |
| | | Transparent conductive film (heating element) | | | | Power supply | | | |
| | | Hall | Carrier | Specific | | electrodes | | TEMP | |
| | | mobility | density | resistance | THKNS | | THKNS | rise | |
| | | [cm²/V · s] | [1/cm³] | [Ωcm] | [nm] | Material | [μm] | PRFM | Adhesion |
| | Ex. 1 | 22.0 | 1.5 × 10²¹ | 2.0 × 10⁻⁴ | 50 | Cu | 20 | A | A |
| | Ex. 2 | 19.5 | 1.4 × 10²¹ | 2.3 × 10⁻⁴ | 50 | Cu | 20 | A | A |
| | Ex. 3 | 18.0 | 1.3 × 10²¹ | 2.7 × 10⁻⁴ | 50 | Cu | 20 | A | A |
| | Ex. 4 | 16.1 | 1.0 × 10²¹ | 3.2 × 10⁻⁴ | 50 | Cu | 20 | A | A |
| | Ex. 5 | 21.0 | 1.2 × 10²¹ | 2.5 × 10⁻⁴ | 50 | Cu | 20 | A | A |
| | Ex. 6 | 20.7 | 1.1 × 10²¹ | 2.6 × 10⁻⁴ | 50 | Cu | 20 | A | A |
| | Ex. 7 | 21.2 | 1.4 × 10²¹ | 2.0 × 10⁻⁴ | 30 | Cu | 20 | A | A |
| | Ex. 8 | 20.9 | 1.4 × 10²¹ | 2.1 × 10⁻⁴ | 30 | Cu | 20 | A | A |
| | Ex. 9 | 20.5 | 1.3 × 10²¹ | 2.4 × 10⁻⁴ | 30 | Cu | 20 | A | A |
| | Ex. 10 | 20.2 | 1.3 × 10²¹ | 2.2 × 10⁻⁴ | 50 | Cu | 20 | A | A |
| | Ex. 11 | 22.0 | 1.5 × 10²¹ | 2.0 × 10⁻⁴ | 50 | Silver paste | 60 | A | A |
| | Comparative | 12.4 | 4.7 × 10²⁰ | 10.7 × 10⁻⁴ | 50 | Cu | 20 | X | A |
| | Ex. 1 | | | | | | | | |
| | Comparative | 21.1 | 1.6 × 10²¹ | 1.9 × 10⁻⁴ | 50 | Cu | 20 | A | X |
| | Ex. 2 | | | | | | | | |

1. A heater comprising:
a substrate;
a transparent conductive film being a heating element;
an intermediate layer disposed between the substrate and the transparent conductive film, the intermediate layer having a first principal surface positioned closer to the transparent conductive film than the substrate; and
at least a pair of power supply electrodes electrically connected to the transparent conductive film, wherein
the intermediate layer contains an organic polymer forming a cured product and inorganic particles dispersed in the cured product, and
the transparent conductive film has a surface having an arithmetic average roughness Ra, specified in Japanese Industrial Standards (JIS) B 0601:2013, of 7.0 nm or less.

2. The heater according to claim 1, wherein
the inorganic particles include at least one of silica and a metal oxide.

3. The heater according to claim 1, wherein
the intermediate layer has a thickness of 0.5 to 8.0 μm.

4. The heater according to claim 1, wherein
a content of the inorganic particles in the intermediate layer is 2.0 to 90% on a weight basis.

5. The heater according to claim 1, wherein
the inorganic particles have an average particle diameter of 4 to 5000 nm.

6. The heater according to claim 1, wherein
a distance between the first principal surface and the transparent conductive film in a thickness direction of the intermediate layer is 500 nm or less.

7. The heater according to claim 1, wherein
the transparent conductive film is a polycrystal.

8. The heater according to claim 1, wherein
the transparent conductive film has a specific resistance of 3.5×10⁻⁴ Ω·cm or less.

9. The heater according to claim 1, wherein
the transparent conductive film has a carrier density of 8.0×10²⁰ cm⁻³ or more as determined by Hall effect measurement.

10. The heater according to claim 1, wherein
the transparent conductive film has a Hall mobility of 14 cm²/(V·s) or more as determined by Hall effect measurement.

11. The heater according to claim 1, wherein
the transparent conductive film includes indium oxide as a main component.

12. The heater according to claim 1, wherein
the pair of power supply electrodes have a thickness of 1.0 μm or more.
